(19) United States
(12) Patent Application Publication
(10) Pub. No.: US 2015/0239312 A1
(43) Pub. Date: Aug. 27, 2015

(54) Tire Traction Management System

(71) Applicant: Abdalla S. Abukashef, Fort Worth, TX (US)

(72) Inventor: Abdalla S. Abukashef, Fort Worth, TX (US)

(21) Appl. No.: 14/631,515

(22) Filed: Feb. 25, 2015

Related U.S. Application Data
(60) Provisional application No. 61/944,169, filed on Feb. 25, 2014.

(51) Int. Cl. B60C 99/00; B60C 27/16; B60C 23/18; B60C 23/20; B60C 23/00; B60C 23/10

(52) U.S. Cl. CPC B60C 99/003; B60C 23/003; B60C 23/10; B60C 23/18; B60C 23/20; B60C 27/16

(57) ABSTRACT

A tire traction management system which monitors and adjusts the temperature and pressure of a wheel. The system includes a tire pressure management system, a fender skirt, a plurality of ducts, a traction tread cover, and a control module. The tire pressure management system attaches to the wheel and regulates the internal fluid pressure to ensure optimum conditions. The plurality of ducts is integrated and distributed about the fender skirt and is in fluid communication with the air-conditioning (AC) and heating system. Warm or cold air flow from the AC and heating system to be expelled onto the wheel to provide in order to heat or cool the wheel. The traction tread cover includes a first half shell and second half shell. The traction tread cover encloses the tread portion of the wheel and provides additional traction to the tire in adverse road conditions.

The current application claims a priority to the U.S. Provisional Patent application Ser. No. 61/944,169 filed on Feb. 25, 2014.

### FIELD OF THE INVENTION

The present invention relates generally to a tire traction management system. More specifically, the present invention includes a fender skirt, a tire pressure management system, and a traction tread cover to ensure that the tire(s) is operating under optimal conditions. The present invention allows for the user to monitor and control the pressure and temperature of the tire(s) to ensure optimal conditions and maximum traction in adverse conditions such as snow and rain.

### BACKGROUND OF THE INVENTION

Millions of automotive vehicles travel on snow covered roads each year. Such road conditions can be extremely dangerous to the occupants of vehicle and any individuals sharing the road. Snow or ice road surfaces are hazardous conditions to motor vehicles because the vehicle's tires are not able to gain enough traction to accelerate, stop, or change directions. This causes numerous accidents which result in property damage and human casualties. Currently, regular rubber tires can be dangerous and do not provide enough traction in snowy/icy weather conditions. There are two means for overcoming these hazardous road conditions, snow tires and chains. Snow tires utilize studs and sipes to increase traction in adverse road conditions. The protruding metal pins, studs, reduce slippage and skidding. However, snow tires reduce traction on dry pavement and therefore are often only used during winters. This method is expensive, cumbersome, and inefficient as it requires the user to own both summer and winter tires that have to be professionally installed and balanced each year. The alternative and a more crude approach is the use of chains. Also known as snow chains, tire chains are metallic chains that are designed to wrap around the tire and increase traction. This approach works to a certain degree but is illegal in many states as the chains damage the road surfaces. It is therefore an object of the present invention to introduce a system which ensures that the tires of an automotive vehicle are adequately prepared and are operating under optimal conditions in hazardous weather conditions such as snowy and icy roads. The present invention is a tire management system that automatically controls the temperature and pressure of a plurality of tires. Additionally, the present invention also includes a means for increasing traction in the snow conditions through an easy to install two-piece tire cover.

### BRIEF DESCRIPTION OF THE DRAWINGS

FIG. 1 is a perspective view of the present invention installed onto the vehicle.

FIG. 2 is an exploded perspective view of the present invention installed onto the vehicle.

FIG. 3 is a perspective view of the present invention installed onto the vehicle with the fender removed, depicting the connection between the air conditioning and heating system and the fender skirt.

FIG. 4 is an exploded perspective view of the fender skirt.

FIG. 5 is a front view of the fender skirt.

FIG. 6 is a cross sectional view of section A depicted in FIG. 5.

FIG. 7 is a schematic of the internal workings of the fender skirt.

FIG. 8 is perspective view of the traction tread cover.

FIG. 9 is an exploded perspective view of the traction tread cover.

FIG. 10 is a schematic depicting the tire pressure management system.

### DETAIL DESCRIPTIONS OF THE INVENTION

All illustrations of the drawings are for the purpose of describing selected versions of the present invention and are not intended to limit the scope of the present invention.

The present invention is a tire traction management system. The system includes a means for monitoring and automatically adjusting the air pressure and temperature of an automotive wheel 1. Additionally, the system includes a physical cover for a tread portion of a tire which increases traction in hazardous conditions such as snow or ice covered roads; the traction cover does not require professional installation. The system may be configured to be used in conjunction with any type of automotive vehicle and tire design. Automotive vehicle types include, but are not limited to, sedans, hatchbacks, pick-up trucks, coupes, off-road vehicles, semi-trailer trucks, buses, mini-vans, and vans to name a few non-limiting examples. The system is especially beneficial for vehicles that carry heavy cargo across long distances and as a result experience a variety extreme road conditions. One such type of vehicle is a semi-trailer truck. The tires of a semi-trailer truck are constantly under stress from extended use, heavy cargo, extreme road conditions, or a combination thereof.

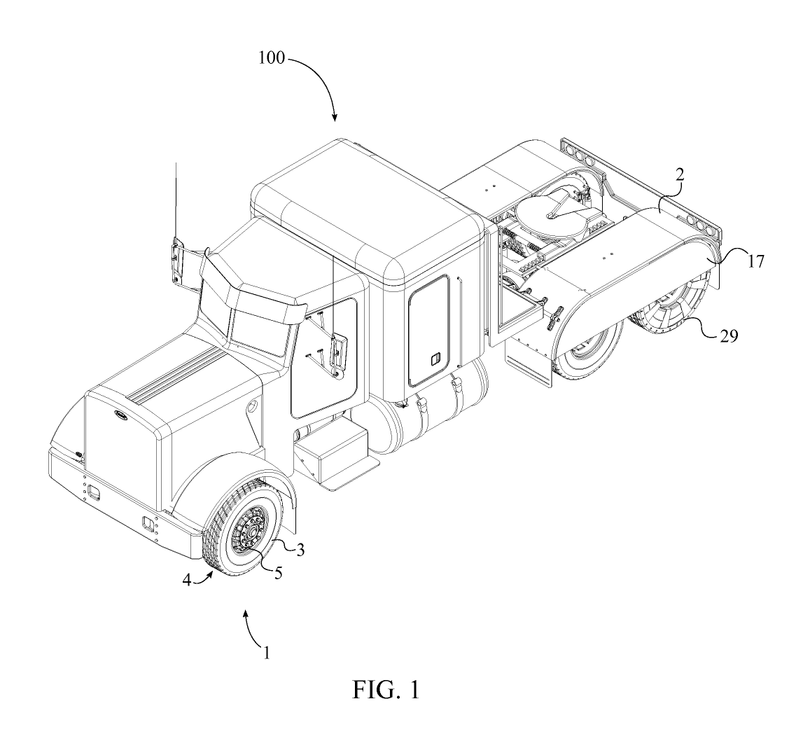

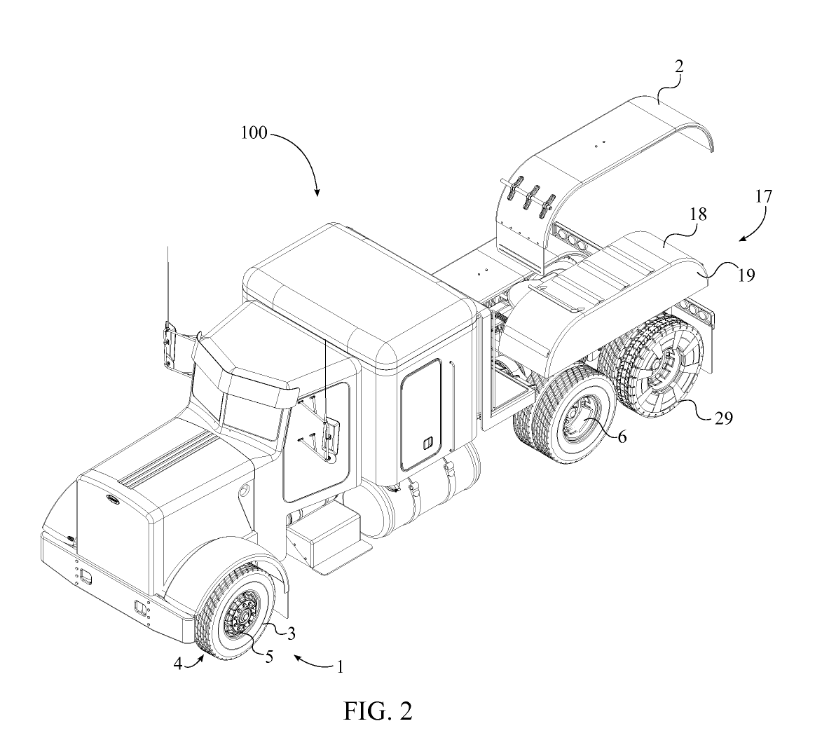

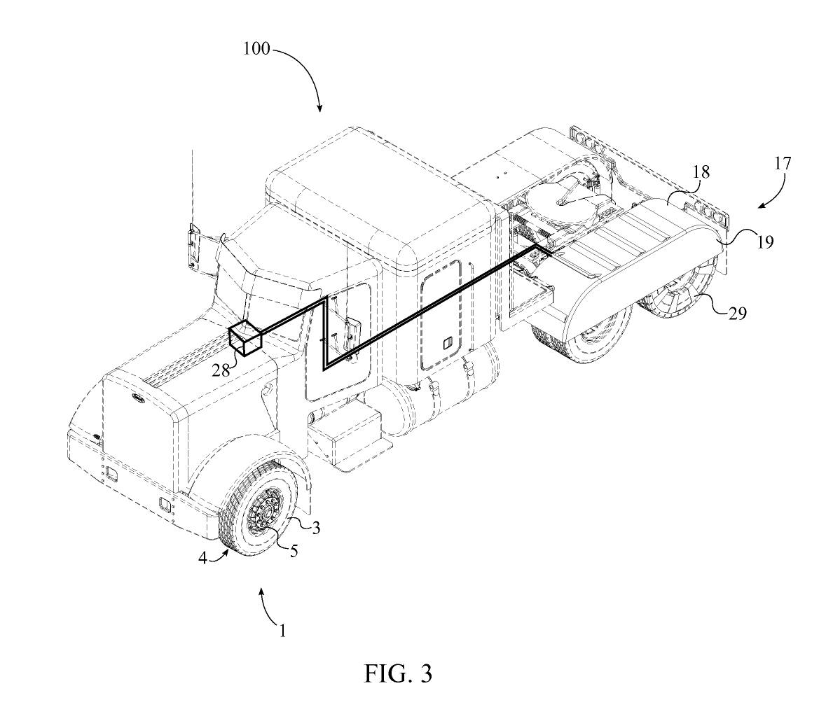

The present invention comprises a tire pressure management system 6, a fender skirt 17, a plurality of ducts 25, a traction tread cover 29, and a control module 35. The system is positioned in and around a wheel 1 of a vehicle 100 as seen in FIG. 1-2. The wheel 1 comprises a tire 3 and a rim 5. The tire pressure management system 6 collects internal pressure and temperature data about the tire 3 through a fluid communication connection. If the pressure of the tire 3 exceeds either the maximum or minimum limits, the tire pressure management system 6 inflates or deflates the tire 3 accordingly to return the internal pressure to proper levels. The fender skirt 17 helps regulate the temperature of the tire 3 through the application of warm or cold air onto the external surfaces of the tire 3. The fender skirt 17 applies air to the tire 3 through the use of the plurality of ducts 25 which are integrated and distributed throughout the fender skirt 17. The input 26 for each of the plurality of ducts 25 is in fluid communication with an air-conditioning (AC) and heating system 28 of the vehicle 100 as seen in FIG. 3, and the output 27 for each of the plurality of ducts 25 is oriented towards the tire 3. The traction tread cover 29 encloses the tread 4 of the tire 3 and provides improved traction for the tire 3 in inclement road conditions such as snow and ice. The tread 4 is the region of the tire which directly makes contact with the road or the ground. The control module 35 is preferably integrated into the interior control mechanisms for the AC and heating system 28 of the vehicle 100 and regulates the status of the tire 3 through the aforementioned components. More specifically, the control module 35 is communicably coupled to the tire pressure management system 6 and the AC and heating system 28 and is consequently able to inflate, deflate, cool, and or heat the tire 3. The present invention may be installed onto multiple tires 3 on the same vehicle 100 and regulated by a single control module 35 that is preferably located within the cabin of the vehicle 100.

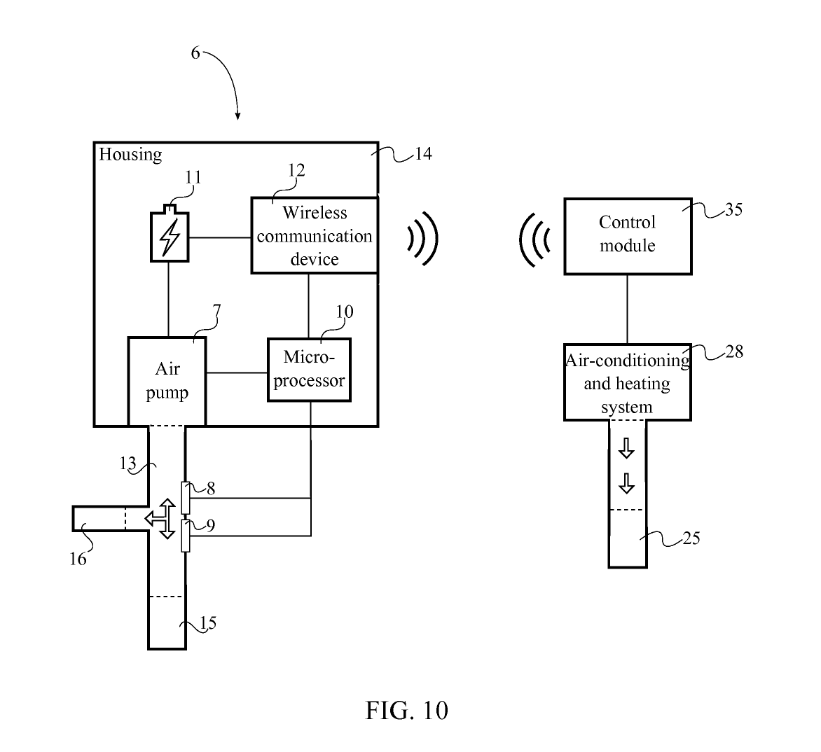

Referring to FIG. 10, the tire pressure management system 6 regulates the pressure within the tire 3 and comprises an air pump 7, a pressure sensor 8, a temperature sensor 9, a microprocessor 10, a rechargeable power supply 11, a wireless communication device 12, a pneumatic valve connector 13, and a housing 14. The air pump 7, microprocessor 10, wireless communication device 12 and the rechargeable power supply 11 are positioned and secured within the housing 14. The housing 14 is preferably water resistant, vibration resistant, and light-weight. The housing 14 may be attached to the rim 5 through a variety of means and mechanisms including, but not limited to, straps, hooks, brackets, permanent industrial adhesives, or be integrated into the manufacturing process of the rim 5. The housing 14 is preferably of symmetrical design such that the balance of the tire 3 is retained. Additional weights may be attached to regions of the rim 5 in order to accommodate for the presence of the pressure management system 6. Because the tire pressure management system 6 is attached to the wheel 1, it is preferred that the components within the housing 14 be secured with vibration dampening material or mechanisms in order to prevent accidental damage during operations.

The pneumatic valve connector 13 is an air-tight adaptor that attaches to the air pump 7 at one end and a valve stem 15 of the tire 3 at the other to allow for the exchange of fluids in between the two components. The pneumatic valve connector 13 may contain a one way valve or a mechanically/electronically operated two way valve like a solenoid valve. Through the pneumatic valve connector 13, the air pump 7 is in fluid communication with the valve stem 15 of the tire 3 allowing the air pump 7 to inflate the tire 3 at any time; it is preferred that the pump be activated only when the wheel 1 is not spinning to ensure the air pump 7 does not experience any unnecessary forces which could cause damage. In alternative embodiments, the rotational motion of the wheel 1 may be used as the mechanism to compress air and inflate the tire 3. The pressure sensor 8 and the temperature sensor 9 are operatively integrated into the pneumatic valve connector 13 such that a pressure reading and a temperature reading may be obtained. Different types of technologies may be used for the pressure sensor 8 and the temperature sensor 9.

The microprocessor 10 receives pressure and temperature data from the pressure sensor 8 and the temperature sensor 9 and relays this data to the control module 35. The control module 35 in turn determines if the relayed data is within the required range and distributes instructions in accordance to reaching the required range. The microprocessor 10 additionally relays those instructions from the control module 35 to the air pump 7 to initiate or stop system operations such as inflating or deflating the tire 3. Consequently, the microprocessor 10 needs to be electronically connected to the air pump 7, the pressure sensor 8, the temperature sensor 9, and the wireless communication device 12. The microprocessor 10 is also communicably coupled to the control module 35 through the wireless communication device 12 so that real-time tire status may be transmitted directly to the control module 35 and be seen by the driver; any traditional wireless communication technologies may be used for this coupling. The air pump 7, the pressure sensor 8, the temperature sensor 9, the wireless communication device 12, and the microprocessor 10 are electrically connected and powered by the rechargeable power supply 11. The rechargeable power supply 11 may comprise a variety of different types of batteries.

In an alternative embodiment of the present invention, the tire 6 pressure management system 6 further comprises an auxiliary tire valve 16 that allows for traditional method of tire inflation and deflation. The auxiliary tire valve 16 is integrated into the pneumatic valve connector 13 and is therefore in fluid communication with the valve stem 15 of the tire 3. A three-way valve connector could be used for this connection. The auxiliary tire valve 16 allows an external pump to be attached to directly inflate the tire 3. The auxiliary tire valve 16 is an alternative means for adjusting the pressure of the tire 3 in case the tire pressure management system 6 is damaged, fails, or stops operating for any reason. In yet another alternative embodiment, the auxiliary tire valve 16 is a solenoid valve that is connected to the microprocessor 10. The solenoid valve would allow the pressure management system 6 to deflate the tire 3 as well.

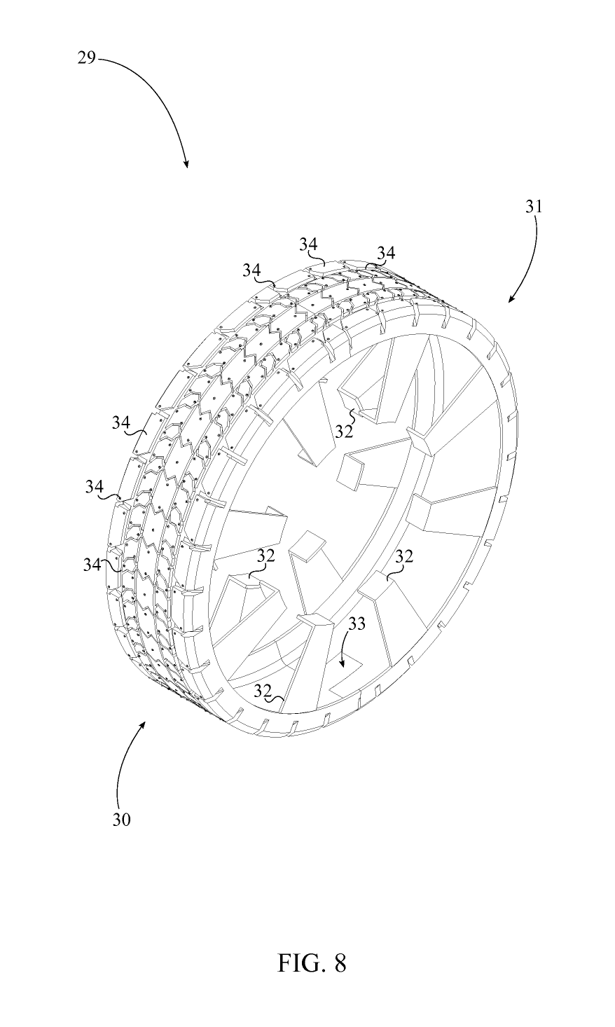

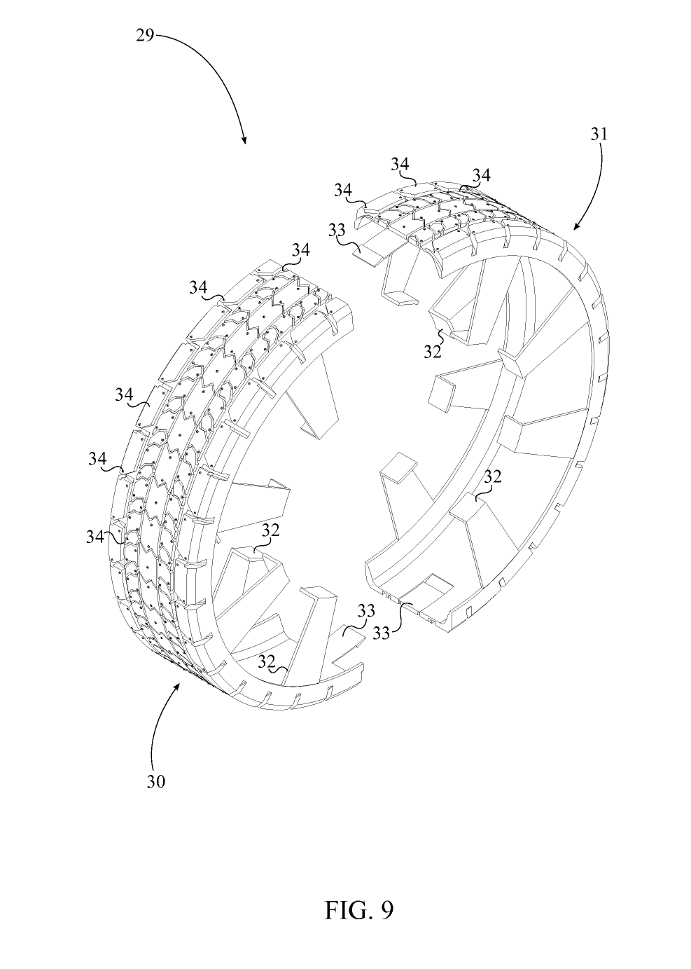

Referring to FIG. 8-9, the traction tread cover 29 is a means to replace the tread 4 in order to increase traction for the tire 3 in adverse road conditions. The traction tread cover 29 comprises a first half shell 30, a second half shell 31, a plurality of fastening mechanism 32, an interlocking mechanism 33, and a plurality of traction features 34. The first half shell 30 and the second half shell 31 are preferable sized to the diameter of the tire 3 and the width of the tread 4. Additionally, the first half shell 30 and the second half shell 31 may be composed of materials such as rubber, synthetic rubber, fabric and wire, and other traditional tire composition. The first half shell 30 and the second half shell 31 are designed to be positioned around the tread 4 of the tire 3 such that the first half shell 30 and the second half shell 31 are diametrically opposed to each other across the tire 3 as seen in FIG. 2. This design covers the entirety of the tread 4, fully changing the operating characteristics of the tire 3 in order to accommodate for snow or ice on the road.

The interior surface of the first half shell 30 and the second half shell 31 is preferably populated by anti-slip elements such as minor channels, semi-annular ribs, and or other similar structures. These elements prevents slippage in between the tire 3 and the traction tread cover 29 and in turn ensures efficient torque transfer from the tire 3 to the traction tread cover 29. To further strengthen the engagement between the tire 3 and the traction tread cover 29 the first half shell 30 and the second half shell 31 are attached to each other by the interlocking mechanism 33. The interlocking mechanism 33 is preferably a female-male snap engagement as seen in FIG. 9. Alternative designs and mechanisms may be used instead or in addition to the aforementioned method. The plurality of fastening mechanisms 32 attaches the first half shell 30 and the second half shell 31 to the rim 5 to further prevent the traction tread cover 29 from rotating relative to the tire 3. The plurality of fastening mechanisms 32 is radially distributed about the first half shell 30 and the second half shell 31, oriented inwards towards the tire 3. The preferred fastening mechanism 32 is an elongated L-bracket that is sized to grip the rim 5, as seen in FIG. 9, which comprises a rubber exterior with a strong internal structure such as a metal band; alternative mechanisms may be used instead or in addition to the aforementioned method. One example of an alternative fastening mechanism 32 is adjustable straps; adjustable straps may be run from one side of the traction tread cover 29, through the rim 5, and attached to the opposite side of the traction tread cover 29.

The plurality of traction features 34 ensures the tire 3 does not lose traction in adverse road conditions by either expelling water from beneath the tire 3 and or by physically “biting” into the surface. The plurality of traction features 34 is externally integrated across the first half shell 30 and the second half shell 31. Included among the types of traction features from the plurality of traction features 34 are, but are not limited to, shell studs, siping systems, water channels, deep tread patterns, and a combination thereof. One of the more important traction features 34 is the shell studs as these are especially effective in providing traction on snow and ice covered surfaces.

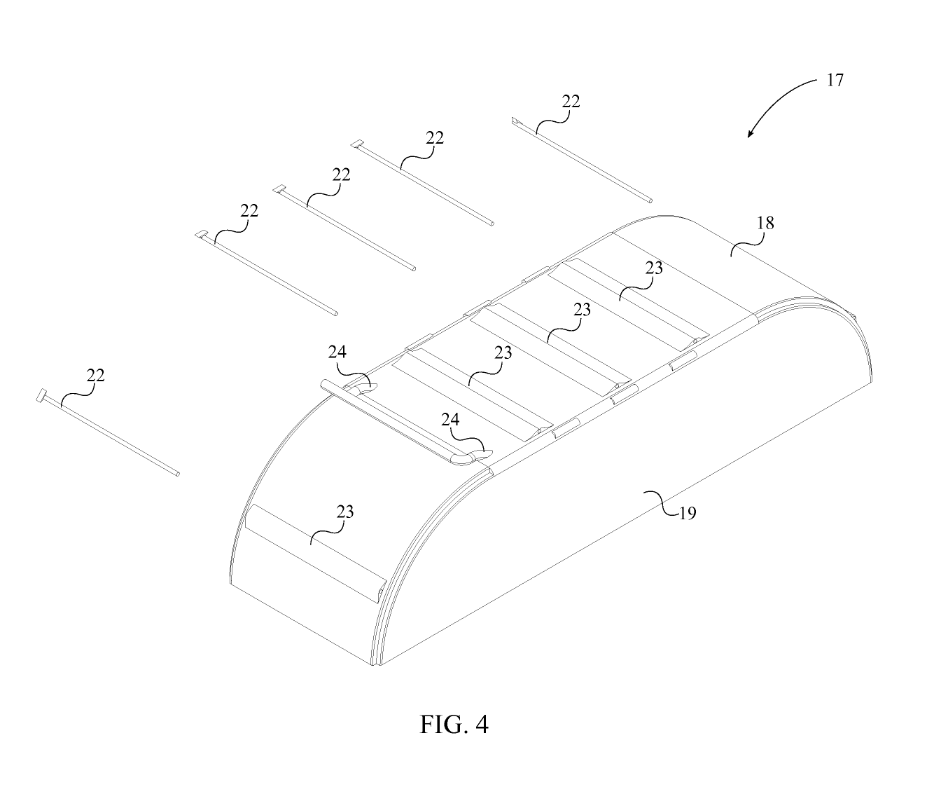

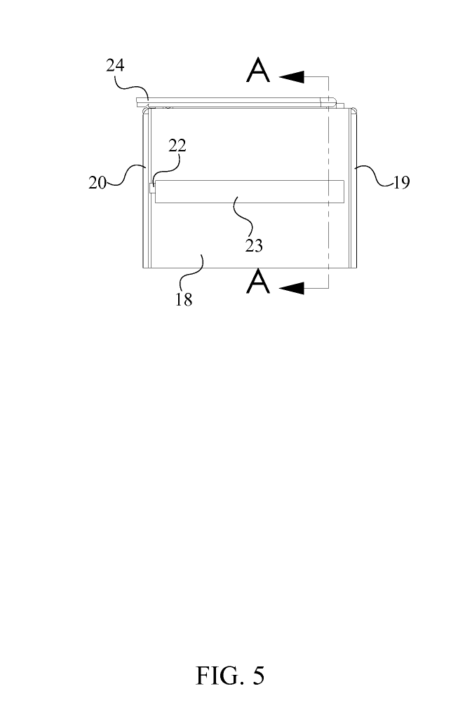

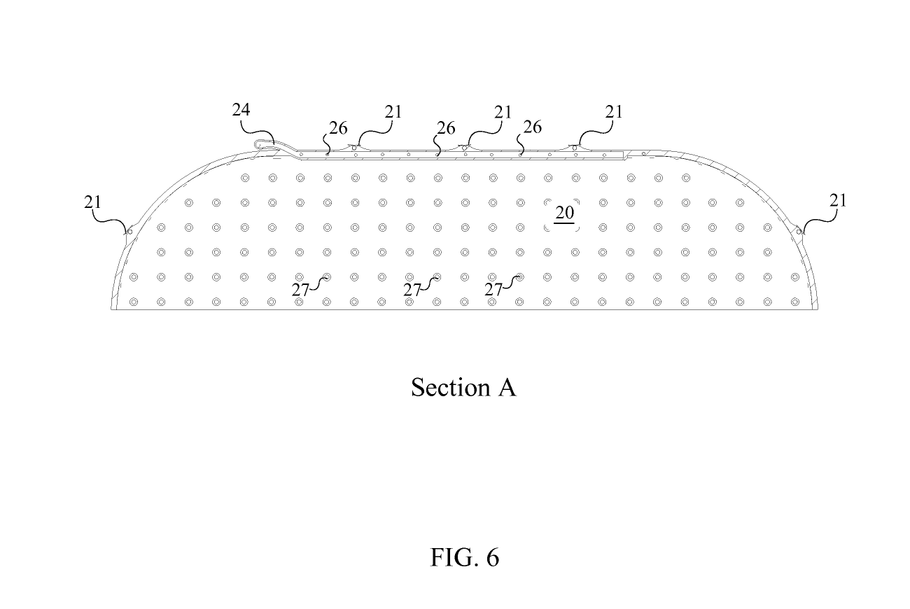

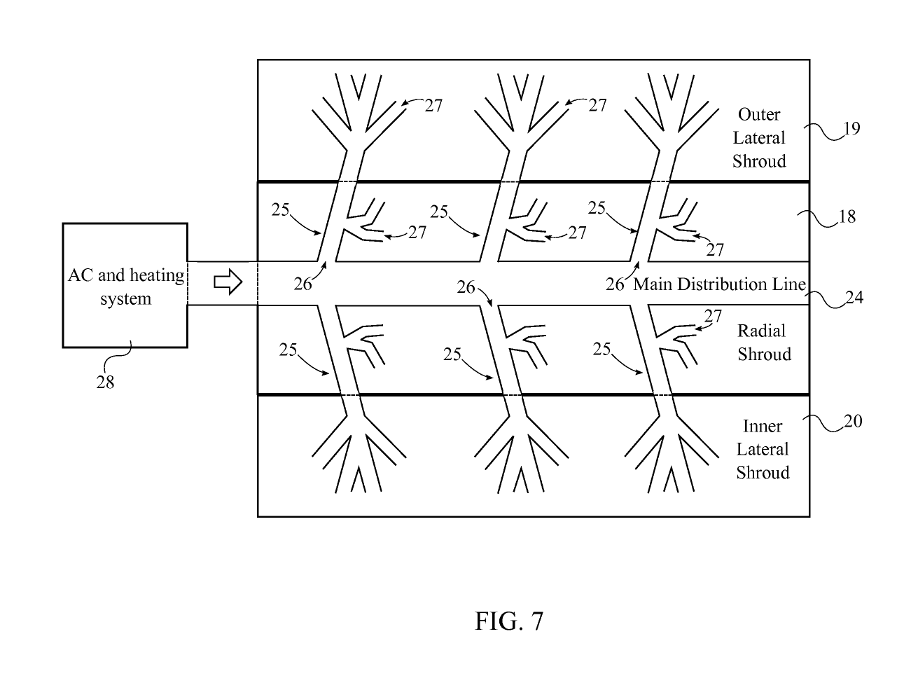

The fender skirt 17 heats or cools the exterior of the tire 3 and ensures the tire 3 is operating at optimum thermal conditions. The fender skirt 17 is positioned around a portion of the wheel 1. The fender skirt 17 comprises a radial shroud 18, an outer lateral shroud 19, an attachment system 21, and an at least one main distribution line 24 as seen in FIG. 4-6. The fender skirt 17 is preferably composed of thin, light, and durable rubber, although alternative material may also be utilized. The at least one main distribution line 24 is in fluid communication with the AC and heating system 28 of the vehicle 100 through plumbing that is designed for said vehicle 100 as seen in FIG. 3. The main distribution line 24 traverses through the radial shroud 18 and is in fluid communication with the input 26 for each of the plurality of ducts 25, allowing air to flow from the AC and heating system 28 to the input 26 and therefore the output 27 for each of the plurality of ducts 25 as seen in FIG. 7. The plurality of ducts 25 is integrated and distributed throughout both the radial shroud 18 and the outer lateral shroud 19. This configuration allows the AC and heating system 28 to supply the fender skirt 17 with either a warm or cold flow of air, which in turn is directed onto the tire 3 from a multitude of sides by the radial shroud 18 and the outer lateral shroud 19. The radial shroud 18 expels air onto the tread 4 and the outer lateral shroud 19 expels air onto the side of the tire 3. The radial shroud 18 is positioned about the tread 4 and mounted to a fender 2 of the wheel 1 by the attachment system 21. The outer lateral shroud 19 is perpendicularly positioned to the radial shroud 18, adjacent to the tire 3, and is hingedly connected to the radial shroud 18. The outer lateral shroud 19 is connected to the radial shroud 18 by a hinge to allow quick and easy access to the tire 3 without requiring special tools to remove any parts of the fender skirt 17.

In one embodiment of the present invention, the fender skirt 17 further comprises an inner lateral shroud 20. Similar to the outer lateral shroud 19, the plurality of ducts 25 is also integrated and distributed throughout the inner lateral shroud 20. The inner lateral shroud 20 is perpendicularly connected to the radial shroud 18, adjacent to the tire 3 and opposite to the outer lateral shroud 19. This configuration positions the inner lateral shroud 20 around the corresponding suspension and drive components of the wheel 1, the inner lateral shroud 20 contains a variety of cutouts which allow for fender skirt 17 to conform to said components without rubbing and or interfering.

The attachment system 21 attaches the fender skirt 17 to the fender 2 of the wheel 1 and comprises a plurality of railings 22 and a plurality of sockets 23. Each of the plurality of railings 22 and each of the plurality of sockets 23 are oriented parallel to a rotation axis of the wheel 1 allowing the fender skirt 17 to be removed by simply applying a lateral force. The plurality of railings 22 is distributed about the tread 4 in between the fender 2 and the radial shroud 18 and is mounted to the fender 2. Each of the plurality of railings 22 is preferably a tubular extrusion spanning the width of the fender 2 and composed of galvanized steel to prevent rusting. The plurality of sockets 23 is connected onto the radial shroud 18, distributed about the tread 4 in between the fender 2 and the radial shroud 18. Each of the plurality of sockets 23 spans a portion of the width of the radial shroud 18 and is sized to receive a corresponding railing from the plurality of railings 22. The fender skirt 17 is attached to the fender 2 of the wheel 1 with each of the plurality of railings 22 being positioned into a corresponding socket from the plurality of sockets 23.

Although the invention has been explained in relation to its preferred embodiment, it is to be understood that many other possible modifications and variations can be made without departing from the spirit and scope of the invention as hereinafter claimed.

What is claimed is:

1. A tire management system comprises:
a wheel of a vehicle;
a tire pressure management system;
a fender skirt;
a plurality of ducts;
a control module;
the wheel comprises a tire and a rim;
each of the plurality of ducts comprises an input and an output;
the tire pressure management system being in fluid communication with the tire;
the fender skirt being positioned around a portion of the wheel;
the plurality of ducts being integrated and distributed throughout the fender skirt;
the output for each of the plurality of ducts being oriented towards the tire;
the input for each of the plurality of ducts being in fluid communication with an air-conditioning (AC) and heating system of the vehicle; and
the control module being communicably coupled to the tire pressure management system and the AC and heating system.

2. The tire management system as claimed in claim 1 comprises:
the tire pressure management system comprises an air pump, a pressure sensor, a temperature sensor, a microprocessor, a rechargeable power supply, a wireless communication device, a pneumatic valve connector, and a housing;
the air pump, the microprocessor, wireless communication device, and the rechargeable power supply being positioned within the housing;
a valve stem of the tire being in fluid communication with the air pump through the pneumatic valve connector;
the pressure sensor and the temperature sensor being operatively integrated into the pneumatic valve connector, wherein the pressure sensor is used to obtain a pressure reading on the tire, and wherein the temperature sensor is used obtain a temperature reading on the tire; and
the microprocessor being electronically connected to the air pump, the pressure sensor, the temperature sensor, and wireless communication device.

3. The tire management system as claimed in claim 2 comprises:
the microprocessor being communicably coupled to the control module though the wireless communication device.

4. The tire management system as claimed in claim 2 comprises:
the rechargeable power supply is electrically connected to the air pump, the pressure sensor, the temperature sensor, the wireless communication device, and the microprocessor.

5. The tire management system as claimed in claim 2 comprises:
the tire pressure management system further comprises an auxiliary tire valve; and
the auxiliary tire valve being in fluid communication the valve stem through the pneumatic valve connector.

6. The tire management system as claimed in claim 1 comprises:
the fender skirt comprises a radial shroud, an outer lateral shroud, an attachment system, and an at least one main distribution line;
the radial shroud being positioned about a tread of the tire;
the radial shroud being mounted to a fender of the wheel by the attachment mechanism;
the outer lateral shroud being perpendicularly positioned to the radial shroud, adjacent to the tire;
the outer lateral shroud being hingedly connected to the radial shroud;
the AC and heating system being in fluid communication with the main distribution line;
the main distribution line traversing through the radial shroud;
the input for each of the plurality of ducts being in fluid communication with the main distribution line; and
the plurality of ducts being integrated and distributed throughout the radial shroud and the outer lateral shroud.

7. The tire management system as claimed in claim 6 comprises:
the fender skirt further comprises an inner lateral shroud;
the inner lateral shroud being perpendicularly connected to the radial shroud, adjacent to the tire and opposite to the outer lateral shroud; and
the plurality of ducts being further integrated and distributed throughout the inner lateral shroud.

8. The tire management system as claimed in claim 6 comprises:
the attachment system comprises a plurality of railings and a plurality of sockets;
each of the plurality of railings and each of the plurality of sockets being oriented parallel to a rotation axis of the wheel;
the plurality of railings being distributed about the tread in between the fender and the radial shroud;
the plurality of railings being mounted to the fender;
the plurality of sockets being distributed about the tread in between the fender and the radial shroud;
each of the plurality of sockets being connected onto the radial shroud; and
each of the plurality of railings being positioned into a corresponding socket from the plurality of sockets.

9. A tire management system comprises:
a wheel of a vehicle;
a tire pressure management system;
a fender skirt;
a plurality of ducts;
a control module;
the wheel comprises a tire and a rim;
each of the plurality of ducts comprises an input and an output;
the tire pressure management system being in fluid communication with the tire;
the fender skirt being positioned around a portion of the wheel;
the plurality of ducts being integrated and distributed throughout the fender skirt;
the output for each of the plurality of ducts being oriented towards the tire;
the input for each of the plurality of ducts being in fluid communication with an air-conditioning (AC) and heating system of the vehicle;
the control module being communicably coupled to the tire pressure management system and the AC and heating system;
the tire pressure management system comprises an air pump, a pressure sensor, a temperature sensor, a microprocessor, a rechargeable power supply, a wireless communication device, a pneumatic valve connector, and a housing;
the air pump, the microprocessor, wireless communication device, and the rechargeable power supply being positioned within the housing;
a valve stem of the tire being in fluid communication with the air pump through the pneumatic valve connector;
the pressure sensor and the temperature sensor being operatively integrated into the pneumatic valve connector, wherein the pressure sensor is used to obtain a pressure reading on the tire, and wherein the temperature sensor is used obtain a temperature reading on the tire; and
the microprocessor being electronically connected to the air pump, the pressure sensor, the temperature sensor, and wireless communication device.

10. The tire management system as claimed in claim 9 comprises:
the microprocessor being communicably coupled to the control module though the wireless communication device.

11. The tire management system as claimed in claim 9 comprises:
the rechargeable power supply is electrically connected to the air pump, the pressure sensor, the temperature sensor, the wireless communication device, and the microprocessor.

12. The tire management system as claimed in claim 9 comprises:
the tire pressure management system further comprises an auxiliary tire valve; and
the auxiliary tire valve being in fluid communication the valve stem through the pneumatic valve connector.

13. The tire management system as claimed in claim 9 comprises:
the fender skirt comprises a radial shroud, an outer lateral shroud, an attachment system, and an at least one main distribution line;
the radial shroud being positioned about a tread of the tire;
the radial shroud being mounted to a fender of the wheel by the attachment mechanism;
the outer lateral shroud being perpendicularly positioned to the radial shroud, adjacent to the tire;
the outer lateral shroud being hingedly connected to the radial shroud;
the AC and heating system being in fluid communication with the main distribution line;
the main distribution line traversing through the radial shroud;
the input for each of the plurality of ducts being in fluid communication with the main distribution line; and
the plurality of ducts being integrated and distributed throughout the radial shroud and the outer lateral shroud.

14. The tire management system as claimed in claim 13 comprises:
the fender skirt further comprises an inner lateral shroud;
the inner lateral shroud being perpendicularly connected to the radial shroud, adjacent to the tire and opposite to the outer lateral shroud; and
the plurality of ducts being further integrated and distributed throughout the inner lateral shroud.

15. The tire management system as claimed in claim 13 comprises:
the attachment system comprises a plurality of railings and a plurality of sockets;
each of the plurality of railings and each of the plurality of sockets being oriented parallel to a rotation axis of the wheel;
the plurality of railings being distributed about the tread in between the fender and the radial shroud;
the plurality of railings being mounted to the fender;
the plurality of sockets being distributed about the tread in between the fender and the radial shroud;
each of the plurality of sockets being connected onto the radial shroud; and
each of the plurality of railings being positioned into a corresponding socket from the plurality of sockets.

16. A tire management system comprises:
a wheel of a vehicle;
a tire pressure management system;
a fender skirt;
a plurality of ducts;
a control module;
the wheel comprises a tire and a rim;
each of the plurality of ducts comprises an input and an output;
the tire pressure management system being in fluid communication with the tire;
the fender skirt being positioned around a portion of the wheel;
the plurality of ducts being integrated and distributed throughout the fender skirt;
the output for each of the plurality of ducts being oriented towards the tire;
the input for each of the plurality of ducts being in fluid communication with an air-conditioning (AC) and heating system of the vehicle;
the control module being communicably coupled to the tire pressure management system and the AC and heating system;
the fender skirt comprises a radial shroud, an outer lateral shroud, an attachment system, and an at least one main distribution line;
the radial shroud being positioned about a tread of the tire;
the radial shroud being mounted to a fender of the wheel by the attachment mechanism;
the outer lateral shroud being perpendicularly positioned to the radial shroud, adjacent to the tire;
the outer lateral shroud being hingedly connected to the radial shroud;
the AC and heating system being in fluid communication with the main distribution line;
the main distribution line traversing through the radial shroud;
the input for each of the plurality of ducts being in fluid communication with the main distribution line; and
the plurality of ducts being integrated and distributed throughout the radial shroud and the outer lateral shroud.

17. The tire management system as claimed in claim 16 comprises:
the tire pressure management system comprises an air pump, a pressure sensor, a temperature sensor, a microprocessor, a rechargeable power supply, a wireless communication device, a pneumatic valve connector, and a housing;
the air pump, the microprocessor, wireless communication device, and the rechargeable power supply being positioned within the housing;
a valve stem of the tire being in fluid communication with the air pump through the pneumatic valve connector;
the pressure sensor and the temperature sensor being operatively integrated into the pneumatic valve connector, wherein the pressure sensor is used to obtain a pressure reading on the tire, and wherein the temperature sensor is used obtain a temperature reading on the tire;
the microprocessor being electronically connected to the air pump, the pressure sensor, the temperature sensor, and wireless communication device;
the microprocessor being communicably coupled to the control module though the wireless communication device;
the tire pressure management system further comprises an auxiliary tire valve; and
the auxiliary tire valve being in fluid communication the valve stem through the pneumatic valve connector.

18. The tire management system as claimed in claim 17 comprises:
the rechargeable power supply is electrically connected to the air pump, the pressure sensor, the temperature sensor, the wireless communication device, and the microprocessor.

19. The tire management system as claimed in claim 16 comprises:
the fender skirt further comprises an inner lateral shroud;
the inner lateral shroud being perpendicularly connected to the radial shroud, adjacent to the tire and opposite to the outer lateral shroud; and
the plurality of ducts being further integrated and distributed throughout the inner lateral shroud.

20. The tire management system as claimed in claim 16 comprises:
the attachment system comprises a plurality of railings and a plurality of sockets;
each of the plurality of railings and each of the plurality of sockets being oriented parallel to a rotation axis of the wheel;
the plurality of railings being distributed about the tread in between the fender and the radial shroud;
the plurality of railings being mounted to the fender;
the plurality of sockets being distributed about the tread in between the fender and the radial shroud;
each of the plurality of sockets being connected onto the radial shroud; and
each of the plurality of railings being positioned into a corresponding socket from the plurality of sockets.
